(19) United States
(12) Patent Application Publication
(10) Pub. No.: US 2026/0280131 A1
(43) Pub. Date: Sep. 17, 2026

(54) RADIATING ELEMENTS HAVING FREQUENCY SELECTIVE SURFACES THAT PROVIDE WIDEBAND SCATTERING SUPPRESSION

(71) Applicant: Outdoor Wireless Networks LLC, Richardson, TX (US)

(72) Inventors: Bo Wu, Allen, TX (US); Peter J. Bisiules, LaGrange Park, IL (US); Chengcheng Tang, Murphy, TX (US); Haifeng Li, Allen, TX (US)

(21) Appl. No.: 19/480,195

(22) PCT Filed: May 3, 2024
(86) PCT No.: PCT/US2024/027677

§ 371 Date: Oct. 30, 2025

Related U.S. Application Data
(60) Provisional application No. 63/464,218, filed on May 5, 2023.

(51) Int. Cl. H01Q 9/16; H01Q 1/24

(52) U.S. Cl. CPC H01Q 9/16; H01Q 1/246

(57) ABSTRACT

A radiating element comprises a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk, and the first dipole arm comprises a meandered conductive trace that overlaps a plurality of conductive patches in the forward direction.

### CROSS-REFERENCE TO RELATED APPLICATION

The present application claims priority under 35 U.S.C. § 119 to U.S. Provisional Application Ser. No. 63/464,218, filed May 5, 2023, the entire content of which is incorporated herein by reference.

### BACKGROUND

The present invention generally relates to radio communications and, more particularly, to base station antennas for cellular communications systems and to radiating elements for such base station antennas.

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with fixed and mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally. Most modem base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to simultaneously transmit and/or receive RF signals at two orthogonal polarizations.

Each of the above-described linear arrays is coupled to two ports of a radio (one port for each polarization). An RF signal that is to be transmitted by a linear array is passed from the radio port to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. The relative phases of the sub-components of the RF signal are set (e.g., using phase delay lines) so that the individual antenna beams generated by each subset of radiating elements constructively combine to narrow the half power beamwidth (“HPBW”) of the generated antenna beams in the elevation (vertical) plane. Since the above-described 2G/3G/4G linear arrays generate static antenna beams, they are often referred to as “passive” linear arrays.

Most cellular operators are currently upgrading their networks to support fifth generation (“5G”) cellular service. One important component of 5G cellular service is the use of so-called “active” beamforming arrays that operate in conjunction with active beamforming radios to dynamically adjust the size, shape and pointing direction of the antenna beams that are generated by the active beamforming array. These active beamforming arrays include multiple columns of radiating elements, with eight columns being the most common. Active beamforming arrays are typically formed using “high-band” radiating elements that operate in higher frequency bands, such as some or all of the 3.1-4.2 GHz and/or the 5.1-5.8 GHz frequency bands, although active beamforming arrays may also be provided that operate in other frequency bands such as the upper portion of the mid-band frequency range (e.g., 2300-2690 MHz). Each column of radiating elements of such an active beamforming array is typically coupled to a respective port of a beamforming radio. The beamforming radio may be a separate device, or may be integrated with the active antenna array. The beamforming radio may dynamically adjust the amplitudes and phases of the sub-components of an RF signal that are fed to each column of the beamforming array to generate antenna beams that have narrowed beamwidths in the azimuth plane (and hence higher antenna gain). These narrowed antenna beams can be electronically steered in the azimuth plane by proper selection of the amplitudes and phases of the sub-components of an RF signal.

In order to avoid having to increase the number of antennas at cell sites, the above-described 5G antennas often include passive linear arrays that support legacy 2G, 3G and/or 4G cellular services. In one popular solution, a 5G active antenna module (i.e., a module that includes an active beamforming array and associated beamforming radio) is mounted behind a passive base station antenna that includes a plurality of 2G, 3G, and/or 4G passive linear arrays. An opening is provided in the reflector of the passive base station antenna so that the antenna beams generated by the active beamforming array can be transmitted through the passive base station antenna. Typically, some of the radiating elements of the 2G/3G/4G passive linear arrays are mounted in front of the radiating elements of the beamforming array. The above-described antenna design is advantageous as the active antenna module may be removable, and hence as enhanced 5G capabilities are developed, a cellular operator may replace the original active antenna module with an upgraded active antenna module without having to replace the passive base station antenna. Herein, the combination of a passive base station antenna that has an active antenna module mounted thereon is referred to as a “passive/active antenna system.”

### SUMMARY

Pursuant to embodiments of the present invention, radiating elements are provided that include a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk, and the first dipole arm comprises a meandered conductive trace that overlaps a plurality of conductive patches in the forward direction.

In some embodiments, the conductive patches define a perimeter.

In some embodiments, the first and second dipole radiators are formed in a dipole radiator printed circuit board that comprises a dielectric substrate, and the meandered conductive trace is part of a first metallization layer on a first major surface of the dielectric substrate and the plurality of conductive patches are part of a second metallization layer on a second major surface of the dielectric substrate. In some embodiments, a plurality of conductive vias that extend through the dielectric substrate physically and electrically connect the meandered conductive trace to respective ones of at least some of the conductive patches.

In some embodiments, the meandered conductive trace forms a conductive loop.

In some embodiments, the meandered conductive trace comprises a plurality of meandered sections, and at least half of the meandered sections overlap respective ones of the conductive patches in the forward direction. In some embodiments, each of the plurality of meandered sections has the same shape. In some embodiments, the plurality of conductive patches comprises a first plurality of conductive patches that each has a respective major surface that has a respective area that exceeds a first value, and a second plurality of conductive patches that each has a respective major surface that has a respective area that is less than a second value, where the second value is at least 25% smaller than the first value. In some embodiments, each of the plurality of meandered sections has the same shape.

In some embodiments, the first through fourth dipole arms are configured to be substantially transparent to RF radiation in the 1.6-2.7 GHz frequency band and in the 3.4-4.0 GHz frequency band.

In some embodiments, the feed stalk comprises a feed stalk printed circuit board that includes a first feed line for the first dipole radiator and a second feed line for the second dipole radiator.

In some embodiments, each of the conductive patches comprises a circular patch or a polygonal patch that has at least six sides.

In some embodiments, the meandered conductive trace comprises a plurality of first meandered conductive sections that overlap respective ones of the conductive patches and a plurality of second meandered conductive sections that do not overlap the conductive patches, where at least some of the second meandered conductive sections have shapes that are different than shapes of the first meandered conductive sections. In some embodiments, at least some of second meandered conductive sections have path lengths that are longer than path lengths of any of the first meandered conductive sections. In some embodiments, at least some of second meandered conductive sections extend farther into an interior of the first dipole arm than do any of the first meandered conductive sections.

Pursuant to further embodiments of the present invention, radiating elements are provided that comprise a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk, and wherein the first dipole arm comprises a conductive loop that overlaps a plurality of conductive patches in the forward direction.

In some embodiments, each of the conductive patches comprises a circular patch or a polygonal patch that has at least six sides.

In some embodiments, the conductive loop comprises a conductive trace that includes a first plurality straight sections and a second plurality of meandered sections. In some embodiments, each straight section connects a respective pair of the meandered sections. In some embodiments, at least half of the meandered sections overlap respective ones of the conductive patches in the forward direction. In some embodiments, each conductive patch overlaps a corresponding one of the meandered sections in the forward direction so that each conductive patch and its corresponding meandered section form a respective unit cell of a frequency selective surface.

In some embodiments, the first and second dipole radiators are formed in a dipole radiator printed circuit board that comprises a dielectric substrate, a first metallization layer that is on a first major surface of the dielectric substrate and a second metallization layer on a second major surface of the dielectric substrate, where the conductive loop is part of the first metallization layer and the conductive patches are part of the second metallization layer. In some embodiments, a plurality of conductive vias extend through the dielectric substrate to physically and electrically connect the conductive loop to respective ones of at least some of the conductive patches.

In some embodiments, the plurality of conductive patches comprises a first plurality of conductive patches that each has a respective major surface that has a respective area that exceeds a first value, and a second plurality of conductive patches that each has a respective major surface that has a respective area that is less than a second value, where the second value is at least 25% smaller than the first value.

In some embodiments, each of the meandered sections has the same shape.

Pursuant to additional embodiments of the present invention, radiating elements are provided that comprise a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk. The first dipole arm comprises a plurality of conductive patches that are interconnected by a plurality of meandered conductive traces, a first additional conductive patch, and a first additional meandered conductive trace that overlaps the first additional conductive patch in the forward direction.

In some embodiments, the first and second dipole radiators are formed in a dipole radiator printed circuit board that comprises a dielectric substrate, a first metallization layer that is on a first major surface of the dielectric substrate and a second metallization layer on a second major surface of the dielectric substrate, and the plurality of conductive patches, the plurality of meandered conductive traces and the first additional meandered conductive trace are each part of the first metallization layer and the first additional conductive patch is part of the second metallization layer. In some embodiments, the first dipole arm comprises a base section, first and second side sections extending from the base section, and a distal section that electrically connects the first and second side sections, and the first additional meandered conductive trace is part of the distal section. In some embodiments, the base section and the first and second side sections each comprises a plurality of conductive patches that are interconnected by a plurality of meandered conductive traces. In some embodiments, a path length of the first additional meandered conductive trace is at least three times longer than an average of the path lengths of the meandered conductive traces that are included in the base section and the first and second side sections. In some embodiments, an average width of the conductive patches that are included in the base section and the first and second side sections is at least three times an average width of the meandered conductive traces that are included in the base section and the first and second side sections.

In some embodiments, the feed stalk comprises a feed stalk printed circuit board that includes a first feed line for the first dipole radiator and a second feed line for the second dipole radiator.

In some embodiments, the first through fourth dipole arms are configured to be substantially transparent to RF radiation in the 1.6-2.7 GHz frequency band and in the 3.4-4.0 GHz frequency band.

In some embodiments, the first additional meandered conductive trace galvanically connects the first side section to the second side section so that the first dipole arm comprises a conductive loop.

Pursuant to yet additional embodiments of the present invention, radiating elements are provided that comprise a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk, and the first dipole arm comprises a frequency selective surface that has a plurality of unit cells, where each unit cell includes a first conductive patch and a second conductive patch that has a surface area that is at least 25% larger than a surface area of the first conductive patch and a conductive trace that overlaps the first and second conductive patches in the forward direction.

Pursuant to other embodiments of the present invention, radiating elements are provided that comprise a feed stalk that includes a frequency selective surface, the frequency selective surface comprising a plurality of unit cells, where each unit cell comprises a meandered conductive trace that overlaps a conductive patch. In some embodiments, the feed stalk comprises a feed stalk printed circuit board, and the meandered conductive trace is on a first side of the feed stalk printed circuit board and the conductive patch is on a second side of the feed stalk printed circuit board. In some embodiments, the radiating element further comprises a dipole radiator printed circuit board mounted at the forward end of the feed stalk printed circuit board, and the frequency selective surface is implemented in a forward end of the feed stalk printed circuit board. In some embodiments, the feed stalk printed circuit board comprises first and second ground lines, and the meandered conductive trace is a portion of the first ground line. In some embodiments, the frequency selective surface comprises a first frequency selective surface, the feed stalk printed circuit board further comprising a second frequency selective surface that comprises a plurality of unit cells, where each unit cell comprises a meandered conductive trace that overlaps a conductive patch, where the meandered conductive trace of the second frequency selective surface is a portion of the second ground line

[symbol]

The present invention also encompasses base station antennas that include any of the above-described radiating elements. These base station antennas may include, for example, a first array of first frequency band radiating elements and a second array of first frequency band radiating elements, the second frequency band encompassing higher frequencies than the first frequency band, where at least one of the first frequency band radiating elements comprises one of the above-described radiating elements.

### BRIEF DESCRIPTION OF THE DRAWINGS

FIG. 1A is a schematic perspective view of a conventional low-band cross-dipole radiating element.

FIG. 1B is a schematic side view of the conventional low-band cross-dipole radiating element of FIG. 1A.

FIG. 2A is a schematic perspective view of a passive/active antenna system that includes a passive base station antenna that may be implemented using low-band radiating elements according to embodiments of the present invention.

FIG. 2B is a schematic front view of the passive/active antenna system of FIG. 2A with the radomes thereof omitted.

FIG. 3A is a schematic plan view of a frequency selective surface that has a low pass filter response.

FIG. 3B is a schematic plan view of a frequency selective surface that has a high pass filter response.

FIG. 3C is a schematic plan view of a frequency selective surface that has a band pass filter response.

FIG. 3D is a schematic diagram that illustrates a three dimensional implementation of the frequency selective surface of FIG. 3C that has reduced sized unit cells.

FIG. 3E is a circuit diagram of the frequency selective surface of FIG. 3D.

FIG. 4A is a schematic plan view of a cross dipole radiating element according to embodiments of the present invention that includes dipole arms formed based on a variation of the frequency selective surface of FIG. 3D.

FIG. 4B is a schematic plan view of one of the unit cells included in the frequency selective surface of FIG. 4A.

FIGS. 4C and 4D are shadow perspective views of unit cells that are modified versions of the unit cell of FIG. 4B.

FIG. 5 is a schematic plan view of a unit cell of an alternative frequency selective surface that could be used to form the dipole arms of the cross-dipole radiating element of FIG. 4A.

FIG. 6 is a schematic plan view of a cross-dipole radiating element according to further embodiments of the present invention.

FIGS. 7A and 7B are schematic plan views of cross-dipole radiating elements according to additional embodiments of the present invention.

FIG. 8A is a schematic plan view of a cloaking cross-dipole radiating element.

FIG. 8B is a schematic plan view of a modified version of the cross-dipole radiating element of FIG. SA according to yet additional embodiments of the present invention.

FIG. 8C is an enlarged schematic plan view of one of the dipole arms of the cross-dipole radiating element of FIG. 8B.

FIG. 9 is a composite schematic plan view of unit cell designs for cross-dipole radiating elements according to still further embodiments of the present invention.

FIG. 10A is a plan view of a conventional feed stalk printed circuit board.

FIG. 10B is a plan view of a cloaked feed stalk printed circuit board according to embodiments of the present invention.

### DETAILED DESCRIPTION

The above-described passive/active antenna systems allow a cellular operator to support both legacy 2G/3G/4G cellular service and 5G cellular service using a single base station antenna system. Unfortunately, however, in practice the radiating elements of the passive 2G/3G/4G arrays that are mounted in front of the 5G beamforming array can cause “scattering” of the RF radiation generated by the 5G beamforming array. Scattering is undesirable as it may reduce the gain of the 5G antenna beams by changing the shape thereof in both the azimuth and elevation planes. For example, scattering tends to negatively impact the beamwidth, beam shape, pointing angle, gain and front-to-back ratio of the 5G antenna beams.

Two different types of scattering can occur. First, conductive structures of the radiating elements of the lower frequency (passive) arrays that are mounted in front of the 5G beamforming array can reflect RF energy transmitted by the radiating elements of the beamforming array. Some of this reflected RF energy may then exit the base station antenna in undesired directions (potentially after further reflecting off of other metal structures in the base station antenna such as the reflector, etc.) or may exit the base station antenna in a desired direction but with a phase that causes the reflected RF energy to destructively combine with non-reflected RF energy. The net result is that when RF energy emitted by the beamforming array reflects off the radiating elements of the passive 2G/3G/4G linear arrays, these reflections generally act to distort the radiation pattern generated by the beamforming array in undesirable ways.

The second type of scattering occurs when a conductive structure of the radiating elements of the passive 2G/3G/4G linear arrays has an electrical length that makes the structure resonant in the operating frequency band of the 5G beamforming array. A conductive structure of a radiating element of one of the passive (lower frequency band) arrays may be resonant in the operating frequency band of the 5G (higher frequency band) beamforming array if, for example, the conductive structure has an electrical length that is about ½ a wavelength or about a full wavelength of a frequency within the operating frequency band of the 5G beamforming array. In many cases, the operating frequency band of the beamforming array may be about four times frequencies within the operating frequency band of the passive low-band linear arrays and about twice frequencies within the operating frequency band of the passive mid-band linear arrays. Since, for example, the dipole arms of the radiating elements of the low-band linear arrays typically have an electrical length of about ¼ of a center wavelength of the low-band operating frequency range, they may have a resonant length with respect to RF energy emitted by the 5G beamforming array. As such, RF energy transmitted by the 5G beamforming array may couple to, for example, the dipole arms of nearby low-band radiating elements, and the higher-band currents formed on these dipole arms generates additional high-band radiation that distorts the high-band antenna beams (since some of the RF energy is being emitted from unintended locations, namely from the low-band dipole arms).

So-called “cloaked” or “cloaking” radiating elements are known in the art that have dipole arms that are designed so that currents will largely not form thereon in response to RF radiation in pre-selected frequency ranges (e.g., currents in the operating frequency band of the high-band radiating elements in the 5G beamforming array). These radiating elements can reduce scattering of higher frequency band radiation by the dipole arms of nearby lower frequency band radiating elements.

Pursuant to embodiments of the present invention, base station antennas are provided that include cloaked radiating elements that have dipole arms that may have reduced impact on nearby arrays of higher frequency band radiating elements. The radiating elements according to embodiments of the present invention may be, for example, low-band radiating elements that have dipole arms that are cloaked with respect to mid-band and high-band RF radiation, or mid-band radiating elements that are cloaked with respect to high-band RF radiation. The radiating elements according to embodiments of the present invention may have very high levels of transparency across wide frequency bands.

In some embodiments, the dipole arms of the radiating elements according to embodiments of the present invention may be implemented as frequency selective surfaces that have a band pass filter response so that the dipole arms will pass RF radiation in at least portions of the mid-band and/or high-band frequency ranges pass (i.e., currents will substantially not form on the dipole arms in response to such RF radiation) while acting as dipole arms in the operating frequency band of the radiating element. In some embodiments, each dipole arm may comprise a meandered conductive trace that overlaps a plurality of conductive patches. The meandered conductive trace may form a closed conductive loop or a conductive loop that is open at one end. The conductive patches may extend around a perimeter of the conductive loop. The conductive patches have a capacitive response. The meandered conductive trace has an inductive response. Forming the meandered conductive trace so that it overlaps the conductive patches increases the capacitance. Moreover, by meandering the conductive trace, the inductance may be increased. Each conductive patch and the section of the meandered conductive trace that overlaps the conductive patch may form a unit cell of the frequency selective surface. The meandered conductive trace may act as the dipole arm when excited by RF radiation in the operating frequency band of the radiating element. RF radiation in the operating frequency bands of nearby higher-band radiating elements may pass through the frequency selective surface.

Herein, a meandered conductive trace refers to a non-linear conductive trace that follows a meandered path to increase the path length thereof. Using meandered conductive traces provides a convenient way to introduce higher levels of inductance in the dipole arm while keeping the physical footprint of the conductive traces small. As will be explained in further detail herein, the meandered conductive traces act as high impedance sections that interrupt currents that otherwise would be induced on the dipole arms in response to RF radiation emitted by nearby mid-band and/or high-band radiating elements. The meandered conductive traces are designed to create this high impedance for mid-band and high-band currents without significantly impacting the ability of the low-band currents to flow on the dipole arms. As such, the meandered conductive traces may reduce induced mid-band and/or high-band currents on the low-band radiating element and consequent disturbance to the antenna patterns of nearby mid-band and/or high-band arrays

[symbol]

In other embodiments, radiating elements are provided that have dipole arms that each comprise a plurality of relatively wide conductive patches that are interconnected by a plurality of relatively narrow meandered conductive traces. One of the meandered conductive traces is an elongated meandered conductive trace that has a path length that is at least twice as long as an average of the path lengths of the remainder of the meandered conductive traces. The elongated meandered conductive trace may overlap two or more conductive patches so that the elongated meandered conductive trace and the two or more conductive patches that it overlaps form a frequency selective surface. This frequency selective surface may pass RF currents in the operating frequency band of the radiating element and may be transparent with respect to RF radiation in an operating frequency band of a higher-band radiating element that is located nearby the radiating element.

In some embodiments, radiating elements are provided that comprise a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk, and the first dipole arm comprises a meandered conductive trace that overlaps a plurality of conductive patches in the forward direction.

In other embodiments, radiating elements are provided that comprise a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk, and the first dipole arm comprises a conductive loop that overlaps a plurality of conductive patches in the forward direction.

In the above embodiments, the conductive patches may define a perimeter (e.g., a perimeter of a polygon or a circle). The first and second dipole radiators may be formed in a dipole radiator printed circuit board that comprises a dielectric substrate. The meandered conductive trace may be part of a first metallization layer on a first major surface of the dielectric substrate and the plurality of conductive patches may be part of a second metallization layer on a second major surface of the dielectric substrate. In some embodiments, a plurality of conductive vias may extend through the dielectric substrate that physically and electrically connect the meandered conductive trace to respective ones of at least some of the conductive patches. In some embodiments, the meandered conductive trace may form a conductive loop.

The meandered conductive trace may comprise a plurality of meandered conductive sections, and at least half of the meandered conductive sections may overlap respective ones of the conductive patches in the forward direction. In some embodiments, each of the plurality of meandered conductive sections may have the same shape. In some embodiments, each of the conductive patches may comprise a circular patch or a polygonal patch that has at least six sides.

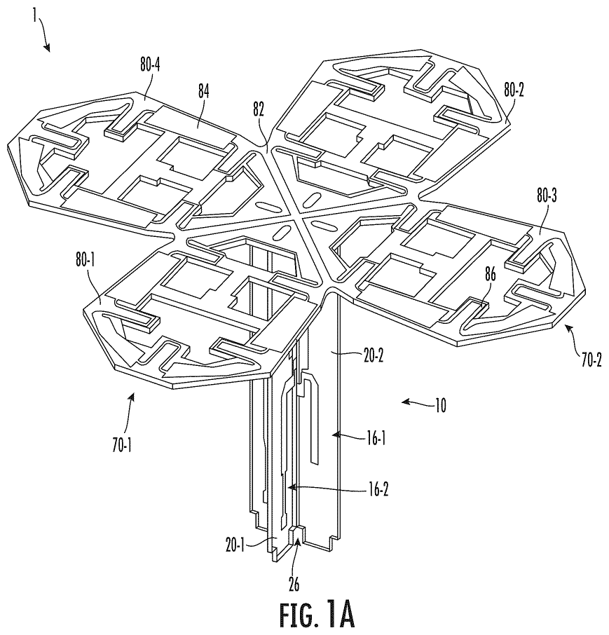

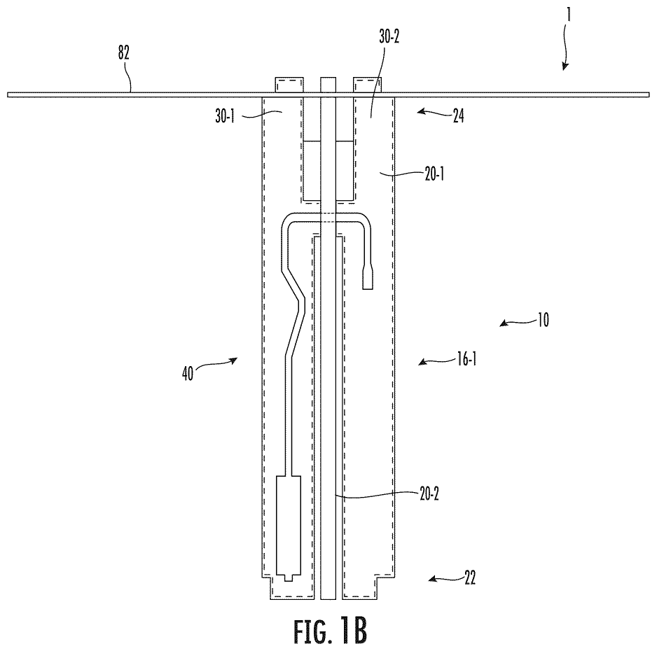

As will be discussed below with reference to FIGS. 1A-1B, radiating elements are known in the art that include a plurality of relatively wide conductive patches that are interconnected by a plurality of relatively narrow meandered conductive traces. Various of the radiating elements according to embodiments of the present invention differ from these conventional radiating elements in that they include at least one meandered conductive trace that has a significantly longer path length, and hence significantly increased inductance. This increased inductance may act to broaden the cloaking bandwidth of the radiating element so that each dipole arm may be cloaked with respect to both mid-band and high-band radiating elements. In addition, the elongated meandered conductive traces allow the dipole arms to achieve a desired electrical length in a smaller physical space, allowing the footprint of the low-band radiating elements according to embodiments of the present invention to be reduced as compared to conventional cloaking low-band radiating elements. Since the widths of many base station antennas are a function of the size of the low-band radiating elements, the radiating elements according to embodiments of the present invention may allow for the size of many base station antennas to be reduced.

In still further embodiments of the present invention, radiating elements are provided that comprise a feed stalk, a first dipole radiator that comprises a first dipole arm and a second dipole arm, and a second dipole radiator that comprises a third dipole arm and a fourth dipole arm. The first and second dipole radiators are mounted adjacent a forward end of the feed stalk. The first dipole arm comprises a plurality of conductive patches that are interconnected by a plurality of meandered conductive traces, a first additional conductive patch, and a first additional meandered conductive trace that overlaps the first additional conductive patch in the forward direction.

In any of the above embodiments, the feed stalk may comprise a feed stalk printed circuit board that includes a first feed line for the first dipole radiator and a second feed line for the second dipole radiator. The first through fourth dipole arms may, for example, be configured to be substantially transparent to RF radiation in the 1.6-2.7 GHz frequency band and in the 3.4-4.0 GHz frequency band.

Before discussing the radiating elements according to embodiments of the present invention it is helpful to discuss the design and operation of a representative conventional cloaked low-band radiating element for a base station antenna, as well as an example base station antenna in which the radiating elements according to embodiments of the present invention may be used.

FIG. 1A is a perspective view of a conventional low-band cross-dipole radiating element 1. FIG. 1B is a shadow side view of cross-dipole radiating element 1. In FIG. 1B, the solid lines are the metallization patterns on a first side of feed stalk printed circuit board of radiating element 1 and the dashed lines are the metallization patterns on a second (opposed) side of feed stalk printed circuit board.

As shown in FIG. 1A, the conventional cross-dipole radiating element 1 includes a feed stalk 10 and a pair of dipole radiators 70-1, 70-2. It should be noted that herein like elements may be referred to individually by their full reference numeral (e.g., dipole radiator 70-2) and may be referred to collectively by the first part of their reference numeral (e.g., the dipole radiators 70). The feed stalk 10 comprises first and second feed stalk printed circuit boards 20-1, 20-2. Each feed stalk printed circuit board 20-1, 20-2 includes a respective RF feed line 16-1, 16-2 that carry RF signals between first and second RF transmission lines (not shown) that connect to the radiating element 1 to pass RF signals to and from the radiating element 1. Each such RF transmission line may comprise, for example, a coaxial cable or a microstrip transmission line on a feed board printed circuit board.

Referring to both FIGS. 1A and 1B, each feed stalk printed circuit board 20 has a base 22 and a distal end 24 that is positioned forwardly of the base 22. The first feed stalk printed circuit board 20-1 includes a slit 26 that extends forwardly from the base 22 thereof, and the second feed stalk printed circuit board 20-2 includes a slit 26 that extends rearwardly from the distal end 24 thereof. Feed stalk printed circuit boards 20-1 and 20-2 are arranged perpendicular to each other with the slits 26 thereof engaged so that the two mated feed stalk printed circuit boards 20-1, 20-2 have a cross-shape when viewed from the front.

Rear portions of each feed stalk printed circuit board 20 may include projections that are inserted through slits in a feed board printed circuit board (not shown). Metallized pads on the projections may be soldered to metallized pads on the feed board printed circuit board to mechanically mount the radiating element 1 on the feed board printed circuit board and to electrically connect the RF feed lines 16-1, 16-2 on the feed stalk 10 to the RF transmission lines on the feed board printed circuit board.

The dipole radiators 70-1, 70-2 are positioned at the distal ends 24 of the feed stalk printed circuit boards 20 and may be (and typically are) physically mounted on the feed stalk printed circuit boards 20. The first dipole radiator 70-1 extends along a first axis and the second dipole radiator 70-2 extends along a second axis that is generally perpendicular to the first axis. The first dipole radiator 70-1 includes first and second dipole arms 80-1, 80-2, and the second dipole radiator 70-2 includes third and fourth dipole arms 80-3, 80-4. The dipole radiators 70-1, 70-2 may be formed in a dipole radiator printed circuit board 82.

Dipole arms 80-1 and 80-2 of first dipole radiator 70-1 are center fed by the first RF feed line 16-1 on the first feed stalk printed circuit board 20-1 and radiate together at a first polarization. In the depicted embodiment, the first dipole radiator 70-1 is designed to transmit and receive signals having a slant +45° linear polarization. Dipole arms 80-3 and 80-4 of second dipole radiator 70-2 are center fed by the second RF feed line 16-2 on the second feed stalk printed circuit board 20-2 and radiate together at a second polarization that is orthogonal to the first polarization. The second dipole radiator 70-2 is designed to transmit and receive signals having a slant −45° linear polarization.

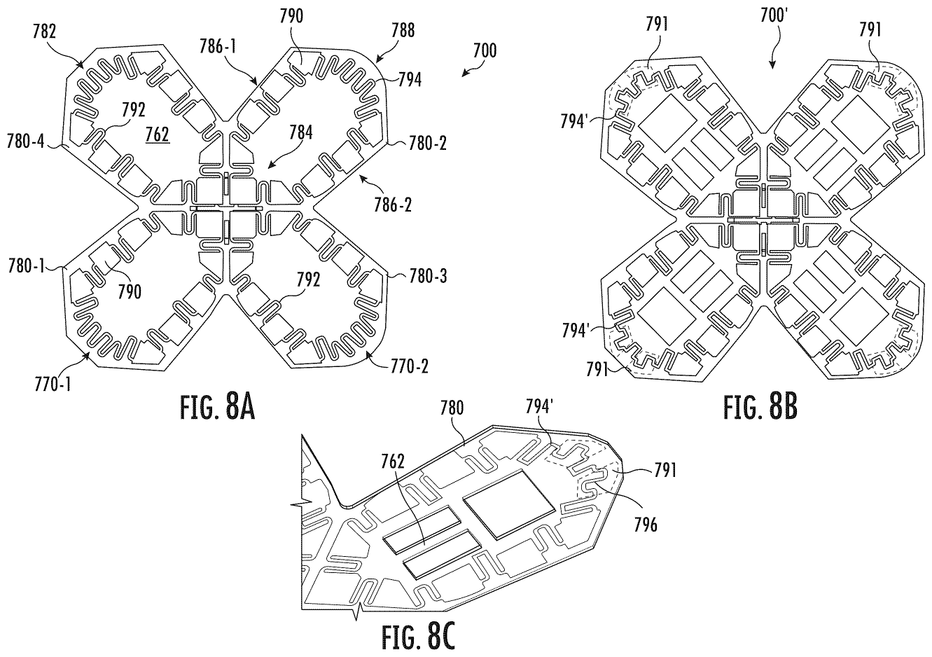

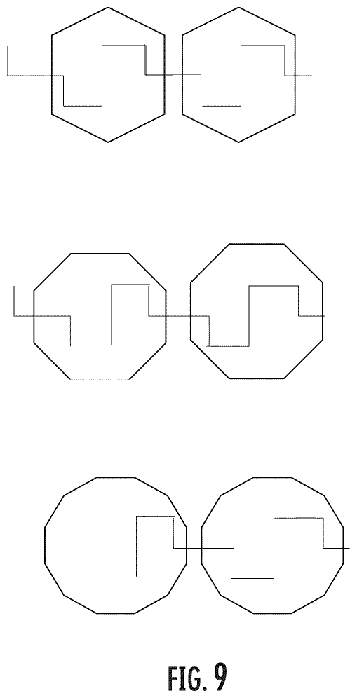

As shown in FIG. 1A, the dipole arms 80 are cloaking dipole arms that are formed as a series of relatively wide conductive patches 84 that are interconnected by relatively narrow meandered conductive traces 86. The average width of each conductive patch 84 may be at least three times, or at least four times, or at least five times the average width of each meandered conductive trace 86. The dipole radiators 70-1, 70-2 are shown as having an elongated “figure 8” shape where each dipole arm 80 is formed as a loop. The meandered conductive traces 86 act as high impedance sections that are designed to interrupt currents in the operating frequency band of the mid-band radiating elements that could otherwise be induced on dipole arms of the low-band radiating elements. The meandered conductive traces 86 may be designed to create this high impedance for currents in the operating frequency band of the mid-band radiating elements without significantly impacting the ability of the low-band currents to flow on the dipole arms. As a result, the low-band radiating elements may be substantially transparent to the mid-band radiating elements, and hence may have little or no impact on the antenna beams formed by nearby mid-band radiating elements.

As shown in FIG. 1B, a twin line transmission line structure is formed on the second side of feed stalk printed circuit board 20-1. The twin line transmission line structure comprises first and second ground lines 30-1, 30-2 that are implemented as first and second metallized regions that extend from the base 22 of the first feed stalk printed circuit board 20-1 to the distal end 24 thereof. Each ground line 30-1, 30-2 is coupled to the ground conductor of the first RF transmission line that feeds radiating element 1 (not shown). The first and second ground lines 30-1, 30-2 may each have an electrical length of about ¼ the center wavelength of radiating element 1.

A signal line 40 is formed on the first side of feed stalk printed circuit board 20-1. The signal line 40 is coupled to the signal conductor of the RF transmission line that feeds the first feed stalk printed circuit board 20-1. The signal line 40 extends forwardly from the base 22 of the first feed stalk printed circuit board 20-1 and travels about two-thirds of the way toward the distal end 24 thereof. The signal line 40 then goes through a first 90° turn to extend transversely across the first side of feed stalk printed circuit board 20-1. Finally, the signal line 40 goes through a second 90° turn to extend rearwardly toward the base 22 of the first feed stalk printed circuit board 20-1.

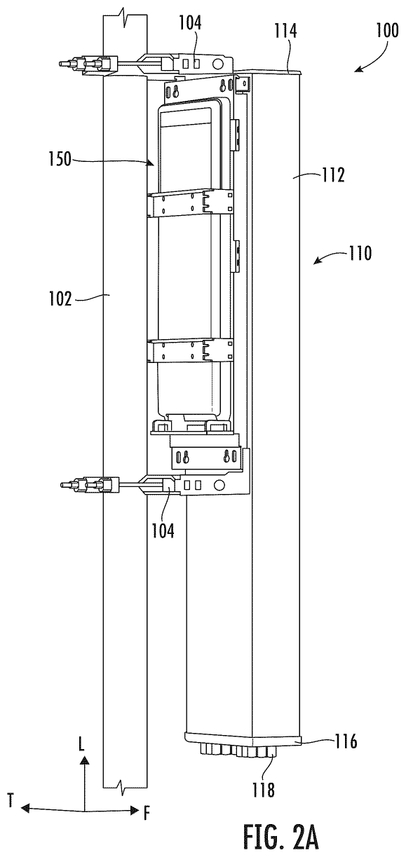

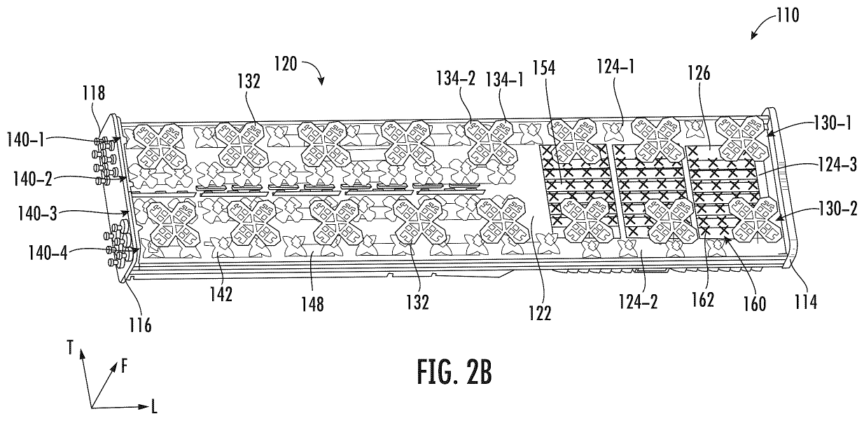

FIGS. 2A-2B illustrate a conventional passive/active antenna system 100 that includes both a passive base station antenna 110 and an active antenna module 150. In particular, FIG. 2A is a schematic rear perspective view of the passive/active antenna system 100, while FIG. 2B is a schematic perspective view of the passive/active antenna system 100 of FIG. 2A with radomes of both the passive base station antenna 110 and the active antenna module omitted. In FIGS. 2A and 2B, the axes illustrate the longitudinal (L), transverse (T) and forward (F) directions of the base station antenna system 100. In the description that follows, the antenna 100 and the radiating elements included therein will be described using terms that assume that the antenna 100 is mounted for normal use on a tower with a longitudinal axis of the antenna 100 extending along a vertical axis and the front surface of the antenna 100 mounted opposite the tower pointing toward the coverage area for the antenna 100.

Referring to FIG. 2A, the passive/active antenna system 100 may be mounted, for example, on an antenna tower 102 using mounting hardware 104. The active antenna module 150 may be mounted directly on a rear surface of the passive base station antenna 110, or may be held in place behind the passive base station antenna 110 by the mounting hardware 104. The front surface of the passive/active antenna system 100 may be opposite the antenna tower 102 facing toward a coverage area of the passive/active antenna system 100. The passive base station antenna 110 includes a tubular radome 112 that surrounds and protects an antenna assembly that is mounted inside the radome 112. A top end cap 114 covers a top opening in the radome 112 and a bottom end cap 116 covers a bottom opening in the radome 112. A plurality of RF ports 118 extend through the bottom end cap 116 and are used to connect the passive base station antenna 110 to one or more external radios (not shown). The active antenna module 150 may be removably mounted behind the passive base station antenna 110 so that the active antenna module 150 may later be replaced with a different active antenna module.

Referring to FIG. 2B, the passive base station antenna 110 includes a reflector assembly 120. The reflector assembly 120 may be referred to herein as a “passive reflector assembly” since it is part of the passive base station antenna 110. The passive reflector assembly 120 includes a main reflector 122 and spaced-apart first and second reflector strips 124-1, 124-2 that extend longitudinally from respective first and second opposed sides of the main reflector 122. The passive reflector assembly 120 may further include a third reflector strip 124-3 that extends in a transverse direction between top ends of the first and second reflector strips 124-1, 124-2. An opening 126 is defined between the first and second reflector strips 124-1, 124-2. For example, the opening 126 may be bounded by a top portion of the main reflector 122, the first and second reflector strips 124-1, 124-2, and the third reflector strip 124-3. At least the main reflector 122 may comprise or include a metallic surface (e.g., a sheet of aluminium) that serves as a reflector and ground plane for the radiating elements of the antenna 100. Various mechanical and electronic components of the antenna (not shown) may be mounted behind the passive reflector assembly 120 such as, for example, phase shifters, remote electronic tilt units, mechanical linkages, controllers, diplexers, and the like.

The passive base station antenna 110 further includes a plurality of passive linear arrays of radiating elements that extend forwardly from the passive reflector assembly 120. The linear arrays may support, for example, 2G, 3G and/or 4G cellular service. In the example passive base station antenna 110 shown in FIGS. 2A-2B, the linear arrays include first and second low-band linear arrays 130-1, 130-2 that are configured to operate in all or part of the 617-960 MHz frequency band. Each low-band linear array 130 comprises a vertically-extending column of low-band radiating elements 132. The passive base station antenna 110 further includes first through fourth mid-band linear arrays 140-1 through 140-4 that are configured to operate in all or part of the 1427-2690 MHz frequency band. Each mid-band linear array 140 comprises a vertically-extending column of mid-band radiating elements 142. Each of the low-band and mid-band linear arrays 130, 140 may generate relatively static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell).

Each of the low-band and mid-band radiating elements 132, 142 may be implemented as dual-polarized radiating elements that include first and second radiators that transmit and receive RF energy at orthogonal polarizations. When such dual-polarized radiating elements are used, each of the low-band and mid-band linear arrays 130, 140 may be connected to a pair of the RF ports 118. The first RF port 118 is connected between a first port of a radio (e.g., a remote radio head) and the first polarization radiators of the radiating elements in one of the linear arrays, and the second RF port 118 is connected between a second port of a radio and the second polarization radiators of the radiating elements in the linear array. RF signals that are to be transmitted by a selected one of the linear arrays 130, 140 are passed from the radio(s) to one of the RF ports 118, and passed from the RF port 118 to a power divider (or, alternatively, a phase shifter assembly that includes a power divider) that divides the RF signal into a plurality of sub-components that are fed to the respective first or second radiators of the radiating elements in the linear array, where the sub-components of the RF signal are radiated into free space.

The low-band and/or mid-band radiating elements 132, 142 may be mounted on feed board printed circuit boards that couple RF signals to and from the individual radiating elements 132, 142. In FIG. 2B, the mid-band radiating elements 142 are shown as being mounted in pairs on a plurality of mid-band feed board printed circuit boards 148 (the low-band radiating elements are likewise mounted on feed board printed circuit boards but they are not visible in the figure). Cables may be used to connect each feed board printed circuit board 148 to other components of the antenna such as diplexers, phase shifters or the like.

Most of the low-band and mid-band radiating elements 132, 142 are mounted to extend forwardly from the main reflector 122. However, low-band linear arrays 130-1, 130-2 extend substantially the full length of the passive/active antenna system 100 and hence extend beyond (above) the main reflector 122. The first and second reflector strips 124-1, 124-2 may provide mounting locations for low-band radiating elements 132 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage, which may improve the performance of the low-band linear arrays 130-1, 130-2.

Each low-band radiating element 132 may comprise a slant −45°/+45° cross-dipole radiating element that includes a slant −45° polarization dipole radiator 134-1 and a slant +45° polarization dipole radiator 134-2. The dipole radiators 134-1, 134-2 may be mounted on a feed stalk (not shown). In some cases, the three uppermost low-band radiating elements 132 that are above the main reflector 122 may be mounted on a frequency selective surface (not shown) that covers the opening 126. This frequency selective surface is described in further detail below. In other cases, the low-band radiating elements 132 may include tilted feed stalks that allow these radiating elements to be mounted on the first and second reflector strips 124-1, 124-2 while the dipole radiators 134 of these radiating elements 132 are in front of the opening 126 (and any FSS covers the opening 126).

The active antenna module 150 includes a multi-column beamforming array 160 of radiating elements 162 and a beamforming radio (not visible in the figures). The multi-column beamforming array 160 may be mounted in a forward portion of the active antenna module 150, and the beamforming radio may be mounted behind the multi-column beamforming array 160. The beamforming array 160 may, for example, comprise a plurality of vertically-extending columns of high-band radiating elements 162 that are configured to operate in all or part of the 3.1-4.2 GHz frequency band (e.g., in the 3.4-4.0 GHz frequency band). The high-band radiating elements 162 are mounted to extend forwardly from a reflector 154 of the active antenna module 150 (herein the “active reflector”). The beamforming radio is capable of electronically adjusting the amplitude and/or phase of the subcomponents of an RF signal that are output to different radiating elements 162 of the multi-column beamforming array 160. For example, each port of the beamforming radio may be coupled to a column of radiating elements of the beamforming array 160, and the amplitudes and phases of the sub-components of the RF signals that are fed to each column may be adjusted so that the generated antenna beams are narrowed in the azimuth plane and pointed in a desired direction in the azimuth plane.

The beamforming array 160 of active antenna module 150 is mounted behind the opening 126 in the passive reflector assembly 114 and behind the frequency selective surface that covers the opening 126. The beamforming array 160 is visible in FIG. 2B as the frequency selective surface and the radome of the passive base station antenna 110 are omitted in FIG. 2B, as is the radome of the active antenna module 150. The opening 126 in the passive reflector assembly 120 allows the antenna beams generated by the beamforming array 160 to pass through the passive base station antenna 110 to provide service to the coverage area of the passive/active antenna system 100.

As discussed above, a frequency selective surface (not shown) may cover the opening 126. Frequency selective surfaces are known in the art. A frequency selective surface is a conductive (usually metal) structure that is designed to have frequency selective responses with respect to RF radiation that is incident thereon. For example, a frequency selective surface may be designed to partially or substantially pass RF energy in a first frequency band while substantially reflecting RF energy in a second different frequency band, thereby acting as a spatial filter. The frequency selective surface included in passive base station antenna 110 may be configured to allow RF energy emitted by the high band radiating elements 162 in the beamforming array 160 to pass therethrough, while the frequency selective surface reflects RF energy in lower frequency bands (and specifically, low-band RF signals that are emitted by the low-band radiating elements 132). The frequency selective surface may be coplanar with the opening 126, in front of the opening 126 or behind the opening 126. The frequency selective surface can have a grid pattern such as a grid of metal patches and/or other metal structures that form a plurality of periodically arranged unit cells. The unit cells may include inductive and/or capacitive structures that couple with each other or with the inductive and/or capacitive structures of adjacent unit cells so that the frequency selective surface is an LC resonant circuit. The LC resonant circuit may be designed to be more transparent to RF energy in a first frequency range than in a second frequency range. A general discussion of frequency selective surfaces may be found in Ben A. Munk, Frequency Selective Surfaces: Theory and Design, ISBN: 978-0-471-37047-5; DOI:10.1002/0471723770; April 2000, Copyright © 2000 John Wiley & Sons, Inc. the contents of which are hereby incorporated by reference as if recited in full herein.

The grid pattern can be arranged in any suitable manner and may be symmetric or asymmetric across a width and/or length of the frequency selective surface. The grid pattern may comprise sub-wavelength periodic microstructures. The metal patches/structures may be arranged in one or more layers. The frequency selective surface may be formed on a substrate such as, for example, a printed circuit board or of stamped sheet metal. In some embodiments, the frequency selective surface may comprise a portion of the passive reflector assembly 120 that is stamped to form the metal grid structure therein. In such cases, the “opening 126” comprises a large number of small openings that act as a large opening with respect to RF energy in the operating frequency band of the beamforming array 160.

One difficulty with the passive/active base station antenna system 100 of FIGS. 2A-2B is that the top three low-band radiating elements 132 in each low-band linear array 130-1, 130-2 are mounted above the main reflector 122 and hence may be directly in front of the high-band beamforming array 160. As such, metal elements of the low-band radiating elements 132 may partially block/reflect the RF radiation emitted by the high-band beamforming array 160 and/or the high-band RF radiation may induce current on metal elements of the low-band radiating elements 132 that then reradiate the high-band radiation in ways that act to distort the shape of the antenna beams generated by the high-band beamforming array 160. In addition, the outer two mid-band arrays 140-1, 140-4 include radiating elements 142 that are mounted above the main reflector 122 adjacent the low-band radiating elements 132. Thus, the top three low-band radiating elements 132 in each low-band linear array 130-1, 130-2 have the potential to negatively impact the antenna beams formed by mid-band arrays 140-1 and 140-4 and by the high-band beamforming array 160.

As discussed above, pursuant to embodiments of the present invention, cross-dipole low-band radiating elements are provided that have dipole arms that may be substantially transparent to RF energy in both the mid-band and high-band operating frequency bands. The radiating elements according to embodiments of the present invention may include frequency selective surfaces that are substantially transparent to RF radiation in selected higher frequency ranges.

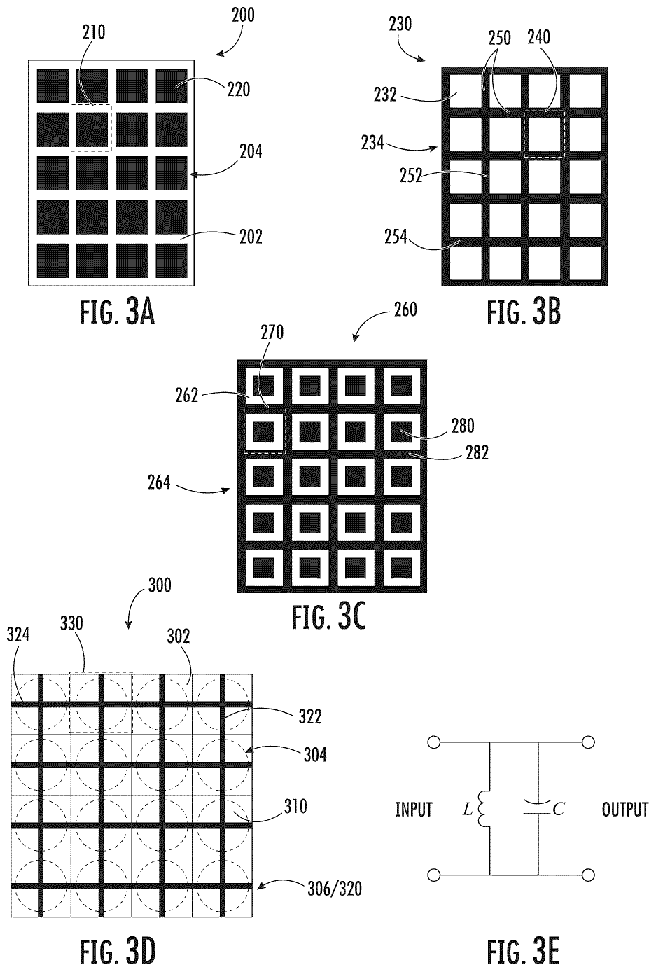

FIG. 3A is a schematic plan view of a frequency selective surface 200 that has a low pass filter response. As shown in FIG. 3A, the frequency selective surface 200 comprises a plurality of unit cells 210 (a total of twenty unit cells 210 are shown), where each unit cell 210 comprises a conductive patch 220. Each conductive patch 220 may comprise a thin metal structure that has a thickness that is much smaller than its length and width. While each conductive patch 220 is shown as having a square shape, it will be appreciated that the conductive patches 220 may have a wide variety of shapes. Adjacent conductive patches 220 are spaced apart from one another and capacitively couple with each other through edge coupling. The frequency selective surface 200 may, for example, be formed using a printed circuit board that includes a dielectric substrate 202 with a metallization pattern 204 on a major surface of the dielectric substrate 202. The conductive patches 220 may comprise the metallization pattern 204.

FIG. 3B is a schematic plan view of a frequency selective surface 230 that has a high pass filter response. As shown in FIG. 3B, the frequency selective surface 230 comprises a metal grid structure 250 that defines a plurality of unit cells 240 (a total of twenty unit cells 240 are shown). The metal grid structure 250 comprises a plurality of longitudinally extending metal traces 252 in combination with a plurality of transversely extending metal traces 254. As shown in FIG. 3B, each unit cell 240 may be viewed as an annular square (or rectangular) conductive patch that merges with its adjacent unit cells 240. The frequency selective surface 230 may be formed using a printed circuit board that includes a dielectric substrate 232 with a metallization pattern 234 on a major surface of the dielectric substrate 232. The metal grid structure 250 may comprise the metallization pattern 234.

FIG. 3C is a schematic plan view of a frequency selective surface 260 that has a band pass filter response. The frequency selective surface 260 may comprise a combination of the frequency selective surface 200 of FIG. 3A and the frequency selective surface 230 of FIG. 3B. As shown in FIG. 3C the frequency selective surface 260 comprises a plurality of unit cells 270 (a total of twenty unit cells 270 are shown), where each unit cell 270 comprises a conductive patch 280 that is surrounded by an annular rectangular patch 282. In other words, the frequency selective surface 260 includes both the conductive patch design of frequency selective surface 200 and the metal grid design of frequency selective surface 230. The frequency selective surface 260 may be formed using a printed circuit board that includes a dielectric substrate 262 with a metallization pattern 264 on a major surface thereof.

FIG. 3D is a schematic diagram that illustrates a three dimensional implementation 300 of the frequency selective surface of FIG. 3C that has reduced sized unit cells. As shown in FIG. 3D, the frequency selective surface 300 may be formed on a printed circuit board that includes a dielectric substrate 302 that has a first metallization pattern 304 on a first major surface thereof and a second metallization pattern 306 on a second major surface thereof. The first metallization layer 304 comprises a plurality of conductive patches 310. The second metallization layer 306 comprises a conductive grid 320 that includes a plurality of longitudinally extending metal traces 322 in combination with a plurality of transversely extending metal traces 324. The longitudinally extending metal traces 322 cross transversely extending metal traces 324 above the centers of the conductive patches 310. Each conductive patch 310 and the cross-shaped portion of the conductive grid 320 that overlaps the conductive patch 310 forms a unit cell 330. Herein, a conductive trace “overlaps” a conductive patch if an axis that is perpendicular to a major surface of the conductive patch passes through both the conductive patch and the conductive trace. By using a multi-layer structure, the size of the unit cells 330 may be reduced as compared to the unit cells 270 of frequency selective surface 260 of FIG. 3C.

FIG. 3E is a circuit diagram of the frequency selective surface 300 of FIG. 3D. As shown in FIG. 3E, the frequency selective surface 300 may comprise a parallel inductor-capacitor (LC) circuit.

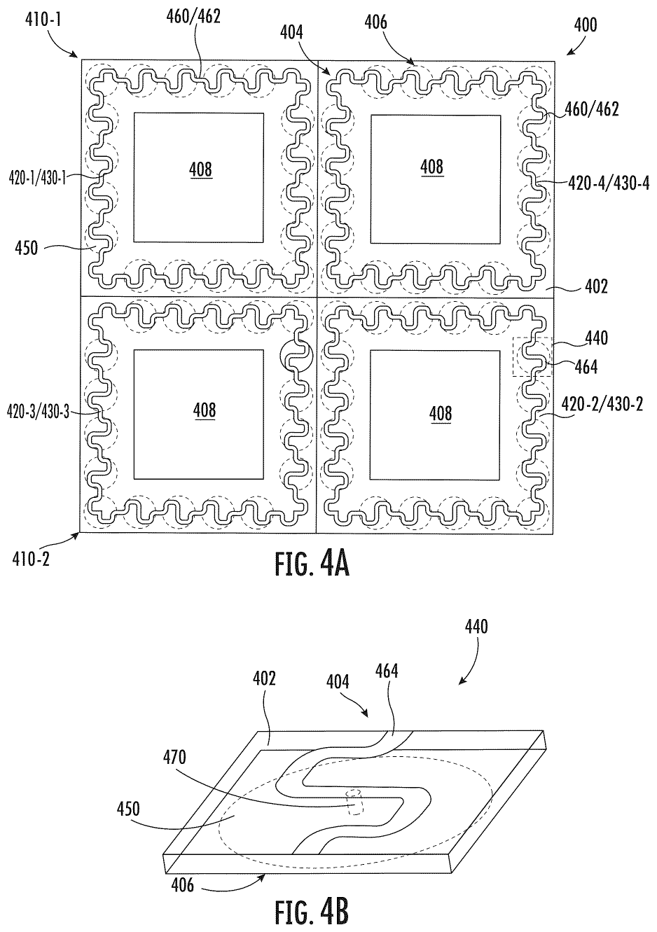

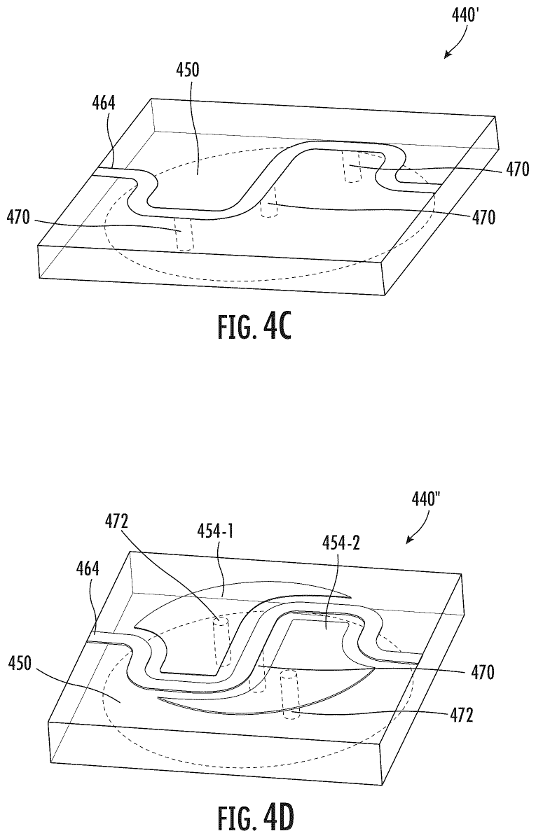

FIG. 4A is a schematic plan view of a cross dipole radiating element 400 according to embodiments of the present invention that includes dipole arms 420 that are formed based on a variation of the frequency selective surface 300 of FIG. 3D. The radiating element 400 includes a first dipole radiator 410-1, and a second dipole radiator 410-2. The dipole radiators 410-1, 410-2 are mounted adjacent (and typically on) the distal end of a feed stalk of radiating element 400. While the feed stalk for radiating element 400 is not shown in FIG. 4A, it will be appreciated that the feed stalk may be identical to the feed stalk 10 of the conventional radiating element 1 that is discussed above with reference to FIGS. 1A-1B. The same is true with respect to the other radiating elements according to embodiments of the present invention that are disclosed herein. It will also be appreciated that any appropriate feed stalk may be included in the radiating elements according to embodiments of the present invention, including printed circuit board based feed stalks, sheet metal feed stalks, or coaxial cable feed stalks as representative examples. In some embodiments, the feed stalk may be implemented using a single feed stalk printed circuit board that includes first and second feed lines that feed the respective first and second dipole radiators of the radiating element. U.S. patent application Ser. No. 18/250,556 (“the '556 application”), filed Apr. 26, 2023 discloses cross-dipole radiating elements having feed stalks that are implemented using a single feed stalk printed circuit board. Any of the feed stalks disclosed in the '556 application may be used to implement the feed stalks for the radiating elements according to embodiments of the present invention. The entire content of the '556 application is incorporated herein by reference.

As shown in FIG. 4A, the first dipole radiator 410-1 includes first and second dipole arms 420-1, 420-2, and the second dipole radiator 410-2 includes third and fourth dipole arms 420-3, 420-4. Dipole arms 420-1 and 420-2 of first dipole radiator 410-1 are center fed and radiate together at a first polarization. In the depicted embodiment, the first dipole radiator 410-1 is designed to transmit and receive signals having a slant +45° linear polarization. Dipole arms 420-3 and 420-4 of second dipole radiator 410-2 are center fed and radiate together at a second polarization that is orthogonal to the first polarization. The second dipole radiator 410-2 is designed to transmit and receive signals having a slant −45° linear polarization.

The dipole radiators 410-1, 410-2 (and hence the dipole arms 420-1 through 420-4) may be implemented in a dipole radiator printed circuit board that includes a dielectric substrate 402 with first and second metallization layers 404, 406 formed on the two major surfaces thereof. The dielectric substrate 402 may have a square shape in example embodiments. A plurality of openings 408 may be formed in the dielectric substrate 402 in order to reduce the dielectric loss in the dipole arms 420.

Each dipole arm 420-1 through 420-4 is formed as a respective frequency selective surface 430-1 through 430-4. Each frequency selective surface 430 comprises a plurality of unit cells 440 that are arranged to define a perimeter. Each unit cell 440 comprises a conductive patch 450 that is formed in the second metallization pattern 406 and a meandered conductive trace section 464 that is formed in the first metallization pattern 404 that overlaps the conductive patch 450. The conductive patches 450 in each dipole arm 420 are formed as circular patches and are arranged to define the perimeter of a square. The meandered conductive trace sections 464 of the unit cells 440 forming each dipole arm 420 are electrically connected in series to provide a continuous meandered conductive trace 460 that forms a conductive loop 462.

As can be seen by comparing FIGS. 3D and 4A, the conductive grid 320 of frequency selective surface 300 is replaced in each dipole arm 420 with a meandered conductive trace 460. Thus, there are no crossing conductive traces in each dipole arm 420, which is in contrast to the conductive grid 320 which includes crossing traces. By replacing the conductive grid 320 of frequency selective surface 300 with the meandered conductive trace 460, each dipole arm 420 may have a shape that is suitable for acting as a dipole arm. However, replacing the plurality of longitudinally-extending traces 322 with the single conductive trace 460 that forms conductive loop 462 and removing the crossing (transversely-extending traces 324 from the conductive grid 320 acts to decrease the amount of inductance in each unit cell 330. Thus, in the dipole arms 420, the conductive trace 460 that forms the conductive loop 462 is meandered, increasing the electrical length and the inductance thereof.

Each dipole arm 420 may be cloaked in, for example, the mid-band frequency range and in at least a portion of the high-band frequency range. Thus, the radiating element 400 may comprise a low-band radiating element that can be used in base station antennas that have both mid-band and high-band radiating elements located in close proximity to the low-band radiating element 400.

FIG. 4B is a schematic plan view of one of the unit cells 440 included in the frequency selective surface of FIG. 4A. As shown in FIG. 4B, each unit cell 440 comprises a conductive patch 450, a meandered conductive trace section 464 that overlaps the conductive patch 450, and a conductive via 470 that extends through the dielectric substrate 402 to electrically connect the meandered conductive trace section 464 to the conductive patch 450. The inclusion of the conductive via 470 may change the impedance of the unit cell 440 to better impedance match the dipole arms 420 to the feed stalk for radiating element 400.

FIG. 4C is a shadow perspective view of a unit cell 440′ that is a modified version of the unit cell 440 of FIG. 4B. As shown in FIG. 4C, the unit cell 440′ differs from unit cell 440 in that it includes a plurality of conductive vias 470 that physically and electrically connect the meandered conductive trace section 464 to the conductive patch 450 instead of a single conductive via 470. The radiating element 400 may alternatively be formed using the unit cells 440′ or a combination of the unit cells 440 and the unit cells 440′.

FIG. 4D is a shadow perspective view of a unit cell 440″ that is another modified version of the unit cell 440 of FIG. 4B. As shown in FIG. 4D, the unit cell 440″ differs from unit cell 440 in that (1) it includes first and second small metal patches 454-1, 454-2 in the first metallization layer 404 that extend on either side of the meandered conductive trace section 464 and (2) additional conductive vias 472 are provided that physically and electrically connect the first and second small metal patches 454-1, 454-2 to the conductive patch 450. The design of unit cell 440″ converts the meandered conductive trace section into a coplanar waveguide like structure. The radiating element 400 may also alternatively be formed using the unit cells 440″ or some combination of the unit cells 440, 440′ and 440′.

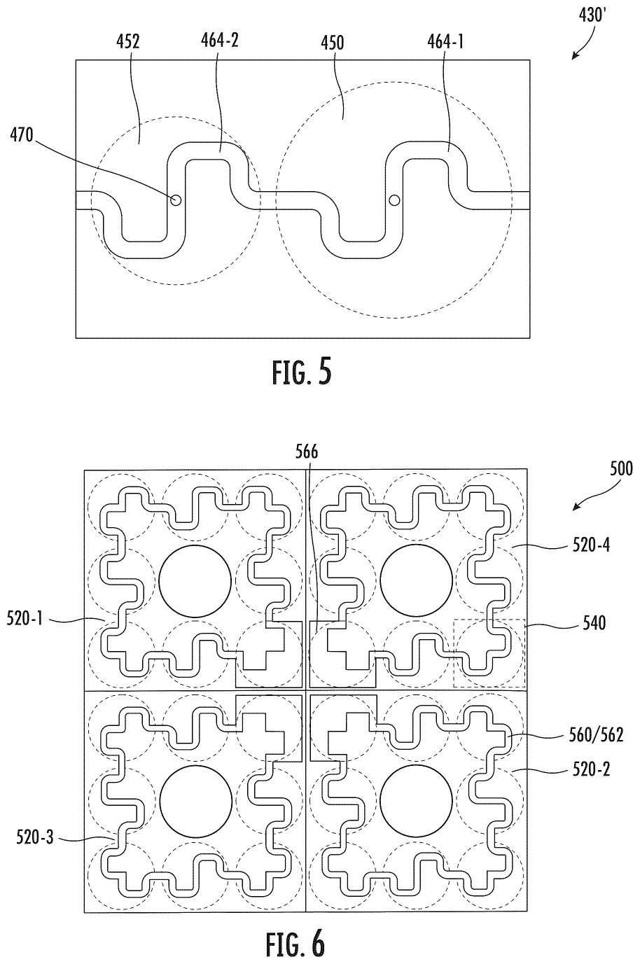

FIG. 5 is a schematic plan view of a unit cell of an alternative frequency selective surface 430′ that could be used in place of each of the frequency selective surfaces 430-1 through 430-4. As shown in FIG. 5, the unit cell of frequency selective surface 430′ includes a first meandered conductive trace section 464-1 that overlaps a conductive patch 450 and a second meandered conductive trace section 464-2 that overlaps a conductive patch 452. The first and second meandered conductive trace sections 464-1, 464-2 may be identical. In contrast, the conductive patch 452 may be smaller than conductive patch 450. In example embodiments, the first conductive patch 450 may have a surface area (where the surface area is the area of one of the major surfaces of the conductive patch) that is at least 25% larger than the surface area of the conductive patch 452. Each meandered conductive trace section 464 is physically and electrically connected to its corresponding conductive patch 450, 452 by a respective conductive via 470. The portion of each unit cell of frequency selective surface 430′ that includes the conductive patch 450 may be designed to be cloaking in the mid-band frequency range and the portion of each unit cell of frequency selective surface 430′ that includes the conductive patch 452 may be designed to be cloaking in the high-band frequency range.

FIG. 6 is a schematic plan view of a cross-dipole radiating element 500 according to further embodiments of the present invention. The cross-dipole radiating element 500 may be similar to the cross-dipole radiating element 400 of FIG. 4A. Thus, the description of radiating element 500 below will focus on the differences between the two radiating elements 400, 500.

As can be seen by comparing FIGS. 4A and 6, the cross-dipole radiating element 500 has smaller dipole arms 520 that each include fewer unit cells 540 as compared to the dipole arms 420 of radiating element 400. This is because radiating element 500 is a mid-band radiating element that is configured to operate in the 1695-2690 MHz frequency band. The base of the conductive loop 560 of each dipole arm 520 of radiating element 500 is formed as a conductive patch 566, whereas the base of the conductive loop 460 of each dipole arm 420 of radiating element 400 is formed as a respective meandered conductive trace section 464. The provision of the conductive patches 566 may improve the impedance match between the dipole arms 520 and a feed stalk (not shown) for radiating element 500.

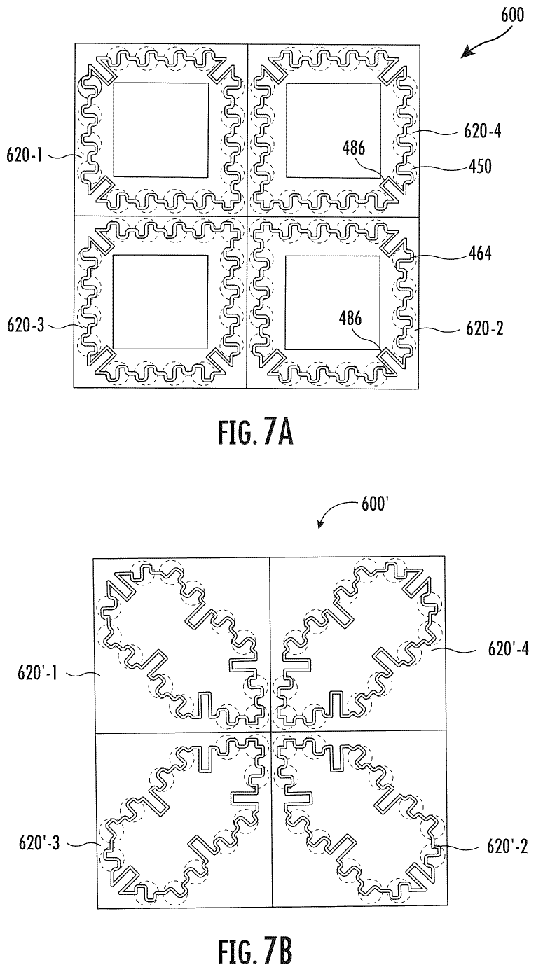

FIGS. 7A and 7B are schematic plan views of cross-dipole radiating elements according to further embodiments of the present invention.

Referring first to FIG. 7A, a cross-dipole radiating element 600 is depicted that is similar to the radiating element 400 of FIG. 4A. The primary difference between the two radiating elements 400, 600 is that each dipole arm 620 of radiating element 600 replaces the meandered conductive trace sections 464 that are located at the outer three corners of the dipole arms 420 with one of the meandered conductive trace sections 86 of the dipole arms 80 of the conventional cloaked radiating element 1 of FIGS. 1A-1B. As such, each dipole arm 620 comprises a meandered conductive trace that includes a plurality of first meandered conductive trace sections 464 that overlap respective ones of the conductive patches 450 and a plurality of second meandered conductive trace sections 486 that do not overlap the conductive patches 450. Moreover, at least some of the second meandered conductive trace sections 486 have shapes that are different than shapes of the first meandered conductive trace sections 464. The path lengths of at least some of second meandered conductive trace sections 486 may be longer than the path lengths of all of the first meandered conductive trace sections 464. At least some of second meandered conductive trace sections 486 extend farther into an interior of the first dipole arm 620 than do any of the first meandered conductive trace sections 464.

Each dipole arm 620 also includes two less conductive patches 450 than the dipole arms 420 of radiating element 400. The addition of the second meandered conductive trace sections 486 may increase the overall inductance of the dipole arms 620, which may improve cloaking performance in the mid-band frequency range.

FIG. 7B illustrates a cross-dipole radiating element 600′ that is a slightly modified version of radiating element 600 of FIG. 7A. In cross-dipole radiating element 600′, each dipole arm 620′ has an oval shape (with the ovals being somewhat elongated) as compared to the square dipole arms 620 of radiating element 620. The oval dipole arms act to increase the footprint of the radiating element 600′ as compared to radiating element 600, but at the same time may improve the cross-polarization discrimination performance. In base station antennas such as passive base station antenna 110 of FIGS. 2A-2B above where the size of the low-band radiating elements 132 does not drive the width of the antenna, the use of low-band radiating elements 600′ may be preferred over low-band radiating elements 600 due to the improved cross-polarization discrimination performance.

A number of cloaked cross-dipole radiating elements are disclosed in U.S. Provisional Patent Application Ser. No. 63/463,928 (“the '928 application”), filed May 4, 2023, that have dipole arms that are modified versions of the dipole arms 80 of conventional low-band radiating element 1 of FIGS. 1A-1B. FIG. 8A is a schematic front view of a representative one of the radiating elements 700 that is disclosed in the '928 application. As shown in FIG. 8A, the radiating element 700 includes a first dipole radiator 770-1 and a second dipole radiator 770-2. The dipole radiators 770-1, 770-2 are mounted adjacent (and typically on) the distal end of a feed stalk (not shown) for radiating element 700.

The first dipole radiator 770-1 includes first and second dipole arms 780-1, 780-2, and the second dipole radiator 770-2 includes third and fourth dipole arms 780-3, 780-4. The dipole radiators 770-1, 770-2 are formed in a dipole radiator printed circuit board that includes a dielectric substrate 762 with a metallization pattern formed on one side thereof. Dipole arms 780-1 and 780-2 of first dipole radiator 770-1 are center fed and radiate together at a slant +45° linear polarization. Dipole arms 780-3 and 780-4 of second dipole radiator 770-2 are center fed and radiate together at a slant −45° linear polarization.

Each dipole arm 780 forms a conductive loop 782 that has a generally oval shape. Each conductive loop 782 includes a base section 784, first and second side sections 786-1, 786-2 that extend from the base section 784, and a distal section 788 that connects distal ends of the first and second side sections 786-1, 786-2. The base section 784 and the first and second side sections 786-1, 786-2 of each conductive loop 782 each comprise a plurality of relatively wide conductive (e.g., metal) patches 790 that are interconnected by a plurality of relatively narrow meandered conductive (e.g., metal) traces 792. In the depicted embodiment, each base section 784 includes three conductive patches 790, each side section 786 includes three conductive patches 790, and the distal end 788 does not include any conductive patches 790. Similarly, in the depicted embodiment, each base section 784 includes two meandered conductive traces 792, each side section 786 includes three meandered conductive traces 792, and the distal end 788 includes a first additional meandered conductive trace 794. Each meandered conductive trace 792, 794 connects a respective pair of adjacent conductive patches 790.

Each conductive patch 790 has a respective width. The width of a conductive patch 790 refers to the maximum extent of the conductive patch 790 in a direction that is parallel to the major surfaces of the conductive patch 790 and perpendicular to the main direction of current flow through the conductive patch 790. Each meandered conductive trace 792, 794 has a respective width. The width of a meandered conductive trace 792, 794 refers to the maximum extent of the meandered conductive trace 792, 794 in a direction that is parallel to the major surfaces of the meandered conductive trace 792, 794 and perpendicular to the main direction of current flow through the meandered conductive trace 792, 794. As shown in FIG. 8A, the width of each meandered conductive trace 792, 794 may be significantly less than the widths of the conductive patches 790. Since the conductive patches 790 need not all have the same widths, reference may be made herein to the average width of the conductive patches 790. Similarly, since the meandered conductive traces 792 may have different widths, reference may be made herein to the average width of the meandered conductive traces 792. Each meandered conductive trace 792 may have a width that is less than 50%, less than 33.3%, less than 25% or less than 10% the average width of the conductive patches 790.

The meandered conductive traces 792 that are included in the base section 784 and in the first and second side sections 786-1, 786-2 of each conductive loop 782 each have an elongated U-shape. This allows each meandered conductive trace 792 to fit in between two closely spaced apart conductive patches 790 while having a path length that exceeds the path length of the conductive patches 790. Herein the term “path length” refers to the distance that an electrical current flowing through the most direct current path through a conductive structure will travel when traversing the conductive structure. Since the conductive patches 790 have generally square or triangular shapes, the path length for the conductive patches 790 will typically be the physical distance between the point where the current enters the conductive patch 790 to the point where the current exits the conductive patch 790. For the meandered conductive traces 792, the “path length” is the physical length of the trace were it possible to pull on both ends of the trace so that the trace extended along an axis. Since the conductive patches 790 and/or the meandered conductive traces 792 need not all have the same path lengths, reference may be made herein to the average path lengths of the conductive segments 790 and/or to the average path length of the meandered conductive traces 792. In the depicted embodiment, each meandered conductive trace 792 has a path length that is about twice the average path length of the conductive patches 790. In other embodiments, each meandered conductive trace 792 may have a path length that is at least 1.5 times, at least twice or at least three times the average path length of the conductive patches 790.

The distal section 788 of each conductive loop 782 comprises a relatively narrow meandered conductive (e.g., metal) trace 794. The meandered conductive trace 794 may have a path length that is longer than, and typically significantly longer than, the average path length of the meandered conductive traces 792 that are included in the base section 784 and first and second side sections 786-1, 786-2 of each conductive loop 782. Thus, herein the meandered conductive trace 794 may be referred to as a first additional meandered conductive trace to help distinguish the elongated meandered conductive trace 794 from the shorter meandered conductive traces 792 included in the base section 784 and first and second side sections 786-1, 786-2 of each conductive loop 782. Each first additional meandered conductive trace 794 may have a path length that is at least twice, at least three times, at least four times or at least six times the average path length of the meandered conductive traces 792 that are included in the base section 784 and first and second side sections 786-1, 786-2 of the respective conductive loops 782. In the depicted embodiment, each first additional meandered conductive trace 794 has a path length that is about than six times the average path length of the meandered conductive traces 792 that are included in the base section 784 and first and second side sections 786-1, 786-2 of the respective conductive loops 782.

The first additional meandered conductive traces 794 may significantly increase the inductance of the equivalent circuit defined by the respective dipole arms 780. This increased inductance may act to broaden the cloaking bandwidth of the radiating element 700 so that each dipole arm 780 may be cloaked with respect to both mid-band RF radiation and high-band RF radiation.

FIG. 8B is a schematic plan view of a cross-dipole radiating element 700′ according to further embodiments of the present invention. FIG. 8C is an enlarged schematic plan view of one of the dipole arms of the cross-dipole radiating element 700′ of FIG. 8B. The cross-dipole radiating element 700′ is a modified version of the radiating element 700.

As can be seen by comparing FIGS. 8A and 8B, the radiating element 700′ is identical to radiating element 700 except that that the dipole radiator printed circuit board of radiating element 700′ includes a second metallization layer on the second major surface of the dielectric substrate 762. A total of eight conductive patches 791 are formed in the second metallization layer. In particular, two conductive patches 791 are formed in the second metallization layer at the distal section 788 of each dipole arm 780. Each pair of conductive patches 791 overlaps an elongated meandered conductive trace 794′, thereby adding additional capacitance at the distal end of each dipole arm 780. As shown in FIG. 8C, in some embodiments, conductive vias 796 may be provided that extend through the dielectric substrate 762 to physically and electrically connect each conductive patch 791 to the meandered conductive trace 794′ that it overlaps. The provision of the conductive vias 796 may improve the improve the impedance match between the dipole arms 780 and the feed stalk for radiating element 700′.

The radiating element 700′ may exhibit good return loss performance (e.g., the maximum return loss is less than −11 dB) and cross-polarization isolation performance may exceed 28.6 dB across the 694-960 MHz operating frequency band. Moreover, the radiating element 700′ may exhibit improved cloaking in the high-band (here 3.3-4.0 GHz) frequency range. The radiating element 700′ may also exhibit improved gain as compared to a conventional cloaking low-band radiating element.

The above-described '928 application discloses a wide variety of cloaking radiating elements. It will be appreciated that the conductive patches 791 that are included in the radiating element 700′ of FIG. 8B may be added to any of the radiating elements of the '928 application to provide numerous additional radiating elements according to embodiments of the present invention.

As described above, the cloaking radiating elements according to embodiments of the present invention include conductive patches that overlap meandered conductive trace sections of a meandered conductive trace. In the above depicted embodiments the conductive patches are shown as being circular patches. It has been found that using circular patches may help reduce scattering and circular patches may also exhibit better passive intermodulation (“PIM”) distortion performance. The use of circular patches also results in a more gradual edge capacitance between adjacent conductive patches, and may allow the conductive patches to be positioned closer together while achieving a desired level of edge capacitance. Moreover, the smaller minimum gap between adjacent conductive patches that may be achieved when using circular patches can provide better continuity for the meandered conductive trace that overlies the conductive patches.

While the use of circular patches may optimize certain performance parameters, it will be appreciated that other shaped patches may be used in further embodiments of the present invention. For example, FIG. 9 illustrates how hexagonal, octagonal and/or dodecagon shaped conductive patches may be used in other embodiments. It will also be appreciated that the conductive patches can have any shape, and that all of the conductive patches in a dipole arm need not have the same shape.

It will also be appreciated that the frequency selective surfaces disclosed herein may also be used to cloak other portions of the radiating elements according to embodiments of the present invention. For example, as discussed in the above-mentioned '556 application, the feed stalks of lower-band radiating elements may also cause scattering of higher-band RF radiation. Thus, by including cloaking structures on the feed stalks of lower-band radiating elements it may be possible to improve the performance of nearby higher-band arrays.

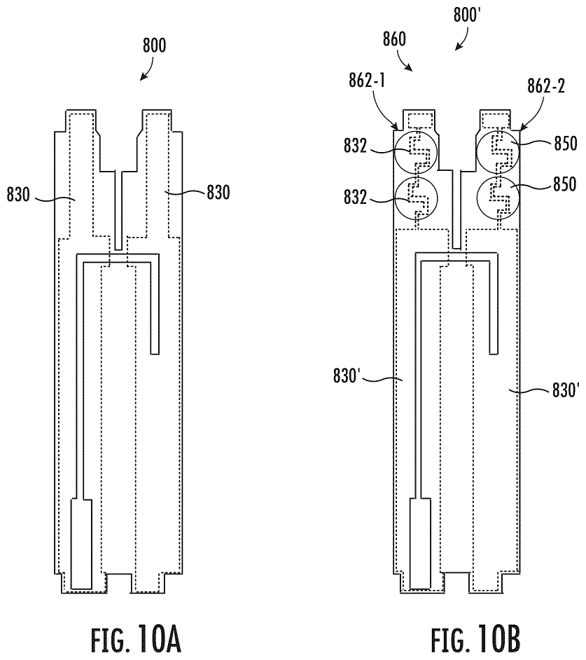

FIG. 10A is a shadow plan view of a conventional feed stalk printed circuit board 800 that includes the RF feed line for a first dipole radiator of a cross-dipole radiating element (not shown). The conventional feed stalk printed circuit board 800 has the same basic design as the feed stalk printed circuit board 20-1 of FIG. 1B, and hence further description thereof will be omitted here. FIG. 10B is a shadow plan view of a feed stalk printed circuit board 800′ according to embodiments of the present invention that is a modified version of feed stalk printed circuit board 800 of FIG. 10A. As can be seen by comparing FIGS. 10A and 10B, feed stalk printed circuit board 800′ differs from feed stalk printed circuit board 800 in that the upper portion of each ground line 830 of feed stalk printed circuit board 800 is replaced with a respective meandered conductive trace 832. Additionally, a pair of conductive patches 850 are provided on the other major surface of feed stalk printed circuit board 800′ so that two conductive patches 850 overlap each meandered conductive trace 832.

Each meandered conductive trace 832 and the conductive patches 850 that it overlaps form a frequency selective surface 860 that, in the depicted embodiment, includes two unit cells 862-1, 862-2. The frequency selective surface 860 may be configured to pass RF signals in the operating frequency band of a radiating element that includes feed stalk printed circuit board 800′ while blocking RF currents in a pre-selected higher frequency range, such as the operating frequency band another higher-band radiating element that is in close proximity to the radiating element that includes feed stalk printed circuit board 800′.

It will be appreciated that many modifications may be made to the radiating elements discussed above without departing from the scope of the present invention. For example, the above-described radiating elements are formed using feed stalk printed circuit boards. In other embodiments, other types of feed stalk implementations may be used such as, for example, sheet metal feed stalks. As another example, while the radiating elements according to embodiments of the present invention are described above as low-band radiating elements that cloak in the mid-band and the high-band frequency ranges, in other embodiments the radiating element could be mid-band radiating elements that are cloaked across a broader range of the high-band operating frequency range.

While the dipole arms of the low-band radiating elements described above are implemented in dipole radiator printed circuit boards, it will be appreciated that embodiments of the present invention are not limited thereto. For example, in other embodiments, the dipole arms may be implemented as sheet metal dipole arms or using other metal structures.

The radiating elements according to embodiments of the present invention may be included in multi-band base station antennas, and may reduce the amount of interaction between the arrays in the different frequency bands. Base station antennas that include the radiating elements according to embodiments of the present invention may be used, for example, as sector antennas in the above-described cellular communications systems.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radiating element, comprising
a feed stalk;
a first dipole radiator that comprises a first dipole arm and a second dipole arm; and
a second dipole radiator that comprises a third dipole arm and a fourth dipole arm;
wherein the first and second dipole radiators are mounted adjacent a forward end of the feed stalk, and the first dipole arm comprises a meandered conductive trace that overlaps a plurality of conductive patches in the forward direction.

2. The radiating element of claim 1, wherein the conductive patches define a perimeter.

3. The radiating element of claim 1, wherein the first and second dipole radiators are formed in a dipole radiator printed circuit board that comprises a dielectric substrate, and the meandered conductive trace is part of a first metallization layer on a first major surface of the dielectric substrate and the plurality of conductive patches are part of a second metallization layer on a second major surface of the dielectric substrate.

4. The radiating element of claim 3, wherein a plurality of conductive vias that extend through the dielectric substrate physically and electrically connect the meandered conductive trace to respective ones of at least some of the conductive patches.

5. The radiating element of claim 1, wherein the meandered conductive trace forms a conductive loop.

6. The radiating element of claim 1, wherein the meandered conductive trace comprises a plurality of meandered sections, and at least half of the meandered sections overlap respective ones of the conductive patches in the forward direction.

7. (canceled)

8. The radiating element of claim 6, wherein the plurality of conductive patches comprises a first plurality of conductive patches that each has a respective major surface that has a respective area that exceeds a first value, and a second plurality of conductive patches that each has a respective major surface that has a respective area that is less than a second value, where the second value is at least 25% smaller than the first value.

9. (canceled)

10. The radiating element of claim 1, wherein the first through fourth dipole arms are configured to be substantially transparent to RF radiation in the 1.6-2.7 GHz frequency band and in the 3.4-4.0 GHz frequency band.

11-12. (canceled)

13. The radiating element of claim 1, wherein the meandered conductive trace comprises a plurality of first meandered conductive sections that overlap respective ones of the conductive patches and a plurality of second meandered conductive sections that do not overlap the conductive patches, where at least some of the second meandered conductive sections have shapes that are different than shapes of the first meandered conductive sections.

14. The radiating element of claim 13, wherein at least some of second meandered conductive sections have path lengths that are longer than path lengths of any of the first meandered conductive sections.

15. The radiating element of claim 13, wherein at least some of second meandered conductive sections extend farther into an interior of the first dipole arm than do any of the first meandered conductive sections.

16. A radiating element, comprising
a feed stalk;
a first dipole radiator that comprises a first dipole arm and a second dipole arm; and
a second dipole radiator that comprises a third dipole arm and a fourth dipole arm;
wherein the first and second dipole radiators are mounted adjacent a forward end of the feed stalk, and wherein the first dipole arm comprises a conductive loop that overlaps a plurality of conductive patches in the forward direction.

17. The radiating element of claim 16, wherein each of the conductive patches comprises a circular patch or a polygonal patch that has at least six sides.

18. The radiating element of claim 16, wherein the conductive loop comprises a conductive trace that includes a first plurality straight sections and a second plurality of meandered sections.

19. The radiating element of claim 18, wherein each straight section connects a respective pair of the meandered sections.

20. The radiating element of claim 18, wherein at least half of the meandered sections overlap respective ones of the conductive patches in the forward direction.

21. (canceled)

22. The radiating element of claim 16, wherein the first and second dipole radiators are formed in a dipole radiator printed circuit board that comprises a dielectric substrate, a first metallization layer that is on a first major surface of the dielectric substrate and a second metallization layer on a second major surface of the dielectric substrate, wherein the conductive loop is part of the first metallization layer and the conductive patches are part of the second metallization layer.

23. The radiating element of claim 22, wherein a plurality of conductive vias extend through the dielectric substrate to physically and electrically connect the conductive loop to respective ones of at least some of the conductive patches.

24. (canceled)

25. The radiating element of claim 18, wherein each of the meandered sections has the same shape.

26-34. (canceled)

35. A radiating element, comprising
a feed stalk;
a first dipole radiator that comprises a first dipole arm and a second dipole arm; and
a second dipole radiator that comprises a third dipole arm and a fourth dipole arm;
wherein the first and second dipole radiators are mounted adjacent a forward end of the feed stalk, and the first dipole arm comprises a frequency selective surface that has a plurality of unit cells, where each unit cell includes a first conductive patch and a second conductive patch that has a surface area that is at least 25% larger than a surface area of the first conductive patch and a conductive trace that overlaps the first and second conductive patches in the forward direction.

36-41. (canceled)
